(19) United States
(12) Patent Application Publication
(10) Pub. No.: US 2013/0191134 A1
(43) Pub. Date: Jul. 25, 2013

(54) METHOD AND APPARATUS FOR DECODING AN AUDIO SIGNAL USING A SHAPING FUNCTION

(71) Applicant: Mi-Suk Lee, Daejeon (KR)

(72) Inventor: Mi-Suk Lee, Daejeon (KR)

(21) Appl. No.: 13/876,691

(22) PCT Filed: Sep. 28, 2011
(86) PCT No.: PCT/KR2011/007147

§ 371 Date: Mar. 28, 2013

(30) Foreign Application Priority Data
Sep. 28, 2010 (KR) 10-2010-0093921
Sep. 27, 2011 (KR) 10-2011-0097636

(51) Int. Cl. G10L 19/008

(52) U.S. Cl. CPC G10L 19/008
USPC 704/500

(57) ABSTRACT

The present invention relates to a method and apparatus for decoding an audio signal using a shaping function. According to one embodiment of the present invention, the method for decoding an audio signal comprises the following steps: taking frame data of the audio signal as an input; restoring a fixed codebook of the frame data using a random function; calculating a shaping function using an adaptive codebook of the frame data; shaping the restored fixed codebook using the shaping function; and synthesizing the audio signal from the frame data using the shaped fixed codebook and adaptive codebook. According to the present invention, the fixed codebook may be restored using the shaping function calculated on the basis of the adaptive codebook upon the occurrence of frame data loss, thus emphasizing a pitch period and reducing the influence of the fixed codebook between the pitch periods so as to reduce the degradation in the quality of the synthesized signal.

### CROSS-REFERENCE(S) TO RELATED APPLICATIONS

The present application claims priority of Korean Patent Application Nos. 10-2010-0093921 and 10-2011-0097636, filed on Sep. 28, 2010, and Sep. 27, 2011, respectively, which are incorporated herein by reference in their entirety.

### BACKGROUND OF THE INVENTION

1. Field of the Invention

Exemplary embodiments of the present invention relate to a method and an apparatus for decoding an audio signal, and more particularly, to a method and an apparatus for decoding an audio signal using a shaping function.

2. Description of Related Art

In order to transmit a voice (audio) signal for voice (audio) communication to a communication network, an encoder for compressing an audio signal converted into a digital signal and a decoder for recovering the audio signal from the encoded data are used. One of the most widely used audio codec (encoder and decoder) technologies is code excited linear prediction (CELP). The CELP codec represents the audio signal by a synthesis filter modeling a vocal track and an input signal of the synthesis filter.

An representative example of the CELP codec may include a G.729 codec and an adaptive multi-rate (AMR) codec. Encoders of these codecs extract synthesis filter coefficients from an input signal of one frame corresponding to 10 or 20 msec and again divide the frame into a subframe of 5 msec to obtain a pitch index and a gain of an adaptive codebook and a pulse index and a gain of a fixed codebook. In addition, the decoder generates an excitation signal using the pitch index and the gain of the adaptive codebook and the pulse index and the gain of the fixed codebook and filters the excitation signal using the synthesis filter, thereby recovering the audio signal.

A frame loss may occur according to a state of a communication network during the transmission of the frame data output from the encoder. In order to reduce quality deterioration of a synthesis signal due to the frame loss, a frame loss concealment algorithm is used. In the frame loss concealment algorithm of the CELP codec, the lost frame is recovered by using a normal frame data, a random function, and a scaling value prior to the frame of which the loss occurs.

### SUMMARY OF THE INVENTION

An embodiment of the present invention is directed to a method and an apparatus for decoding an audio signal capable of reducing quality deterioration of a synthesized signal by emphasizing a pitch period and reducing a fixed codebook influence between pitch periods by recovering a fixed codebook using a shaping function calculated based on an adaptive codebook when a frame data loss occurs.

The objects of the present invention are not limited to the above-mentioned objects and therefore, other objects and advantages of the present invention that are not mentioned may be understood by the following description and will be more obviously understood by exemplary embodiments of the present invention. In addition, it can be easily appreciated that objects and advantages of the present invention may be implemented by means and a combination thereof described in claims.

A method for decoding an audio signal includes: receiving frame data of the audio signal; recovering a fixed codebook of the frame data using a random function; calculating a shaping function using an adaptive codebook of the frame data; shaping the recovered fixed codebook using the shaping function; and synthesizing the audio signal from the frame data by using the shaped fixed codebook and the adaptive codebook.

An apparatus for decoding an audio signal includes: an input unit receiving frame data of the audio signal; a fixed codebook recovery unit recovering a fixed codebook of the frame data using a random function; a shaping unit calculating a shaping function using an adaptive codebook of the frame data and shaping the recovered fixed codebook using the shaping function; and an audio signal synthesis unit synthesizing the audio signal from the frame data by using the shaped fixed codebook and the adaptive codebook.

### BRIEF DESCRIPTION OF THE DRAWINGS

FIG. 1 is a diagram illustrating a configuration of a CELP encoder.

FIG. 2 is a diagram illustrating a configuration a CELP decoder.

FIG. 3 is a graph of an adaptive codebook of a normally received voiced sound signal frame.

FIG. 4 is a graph of a fixed codebook of a normally received voiced sound signal frame.

FIG. 5 is a graph of a fixed codebook recovered by an existing algorithm when a frame loss occurs.

FIG. 6 is a graph of a fixed codebook calculated by a method for decoding an audio signal in accordance with the present invention, when the frame loss occurs.

FIG. 7 is a flow chart of a method for decoding an audio signal by a CELP decoder.

FIG. 8 is a flow chart of a decoding algorithm in accordance with the embodiment of the present invention.

FIG. 9 is a diagram illustrating a configuration of an apparatus for decoding an audio signal in accordance with the embodiment of the present invention.

### DESCRIPTION OF SPECIFIC EMBODIMENTS

Exemplary embodiments of the present invention will be described below in more detail with reference to the accompanying drawings. Only portions needed to understand an operation in accordance with exemplary embodiments of the present invention will be described in the following description. It is to be noted that descriptions of other portions will be omitted so as not to make the subject matters of the present invention obscure.

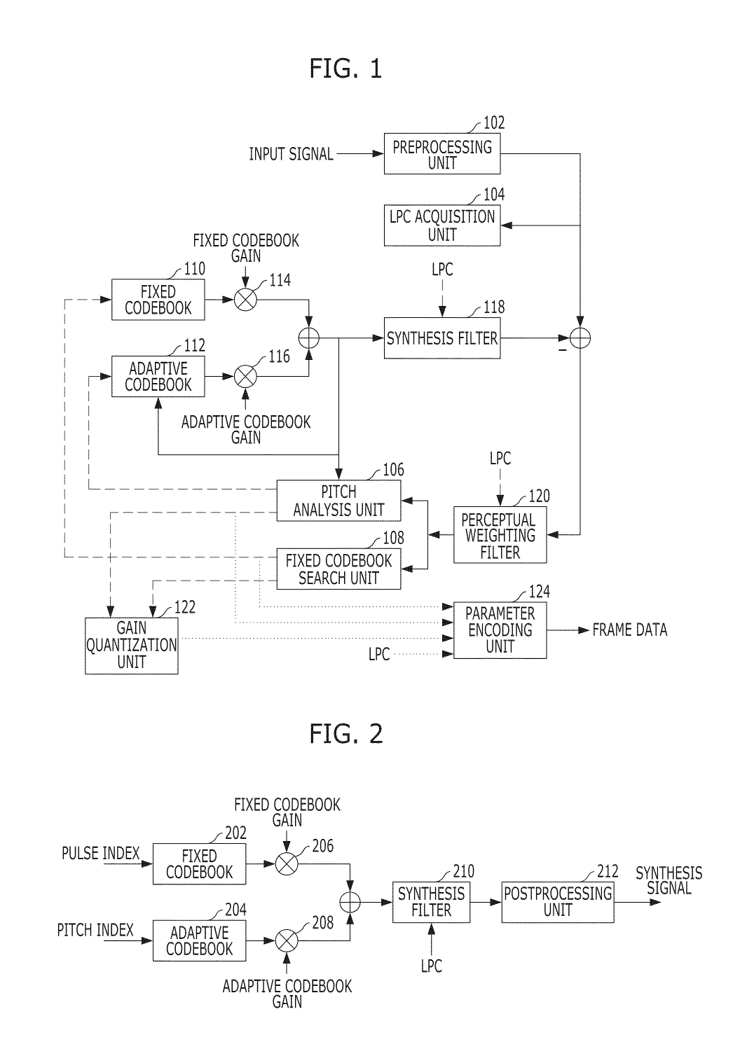

FIG. 1 is a diagram illustrating a configuration of a CELP encoder.

A preprocessing unit 102 scales an input signal and performs high band pass filtering. In this case, the input signal may have a length of 10 msec or 20 msec and is configured by a plurality of subframes. In this case, the subframe may generally have a length of 5 msec.

An LPC acquisition unit 104 extracts a linear prediction coefficient (LPC) corresponding to a synthesis filter coefficient from the preprocessed input signal. Then, the LPC acquisition unit 104 quantizes the extracted LPC and interpolates the LPC of the previous frame to acquire the synthesis filter coefficients of each subframe.

A pitch analysis unit 106 analyzes a pitch of the input signal in a subframe unit to acquire a pitch index and a gain of an adaptive codebook. The acquired pitch index is used to reproduce an adaptive codebook value from an adaptive codebook module 112. Further, a fixed codebook search unit 108 searches a fixed codebook of the input signal in the subframe unit to acquire a pulse index and a gain of the fixed codebook. The acquired pulse index is used to reproduce the fixed codebook value from a fixed codebook module 110. The adaptive codebook gain and the fixed codebook gain are quantized by a gain quantization unit 122.

An output from the fixed codebook module 110 reproduced by a pulse index is multiplied by the quantized gain of the fixed codebook 114. An output from the adaptive codebook module 112 reproduced by the pitch index is multiplied by the quantized gain of the adaptive codebook 116. An excitation signal is generated by adding the adaptive codebook value and the fixed codebook value that are multiplied by the gain.

The generated excitation signal is input to the synthesis filter 118. Thereafter, an error between the input signal preprocessed in the preprocessing unit 102 and the output signal from the synthesis filter 118 is filtered by a perceptual weighting filter 120 reflecting human auditory characteristics and then, the pitch index and the quantized gain and the pulse index and the quantized gain of which the error signal is smallest are obtained, which are in turn transmitted to a parameter encoding unit 124. The parameter encoding unit 124 encodes the pitch index of the adaptive codebook, the pulse index of the fixed codebook, and the output and the LPC parameter of the gain quantization unit 122 in a type appropriate for transmission to output frame data. The output frame data are transmitted to a decoder through a network, or the like.

FIG. 2 is a diagram illustrating a configuration of a CELP decoder.

The decoder recovers a fixed codebook 202 and an adaptive codebook 204 through the pulse index and the pitch index transmitted from the encoder. Then, the output of the fixed codebook 202 is multiplied by the fixed codebook gain (206) and the output of the adaptive codebook 204 is multiplied by the adaptive codebook gain (208). The excitation signal is recovered by adding the adaptive codebook value and the fixed codebook value that are multiplied by the gain. The recovered excitation signal is filtered in the synthesis filter 210 formed of coefficients obtained by interpolating the LPC coefficient transmitted from the encoder. The output of the synthesis filter 210 is post-processed in a post-processing unit 212 to recover an audio signal.

Meanwhile, the loss of the frame data may occur according to a network state while the frame data output through the encoder of FIG. 1 are transmitted to the decoder of FIG. 2. As a result, the loss of the frame data leads to quality deterioration of the audio signal synthesized in the decoder. In order to reduce the quality deterioration of the audio signal, most codecs embed a frame loss concealment algorithm.

For example, the N−1-th frame data are normally received during the transmission of the frame data of the encoder and when the N-th frame data are lost, the frame loss is processed as follows according to the existing algorithm. First, the synthesis filter coefficients of the N-th frame are recovered by using the synthesis filter coefficients of the N−1-th frame. Further, the pitch index of the adaptive codebook uses the pitch index of the final subframe of the N−1-th frame as it is and is recovered using the pitch index of the subframes. In addition, the gains of the adaptive codebook and the fixed codebook are obtained based on the gains of the previous subframes and are then scaled. Further, the fixed codebook is recovered using the random function instead of the pulse index. The audio signal of the lost frame is synthesized using the recovered frame data.

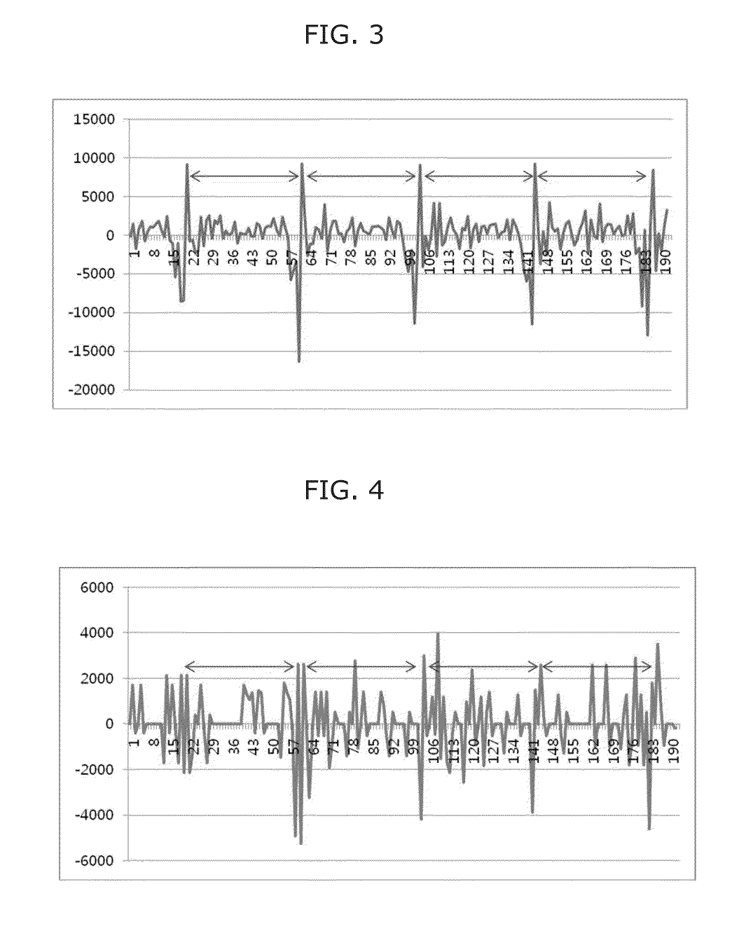

Among the excitation signals input to the synthesis filter, the adaptive codebook models the pitch that is a periodic component and the fixed codebook models the remaining signal from which the pitch component is removed. However, in the case of the voiced sound, some pitch components remain in the fixed codebook. FIG. 3 is a graph of an adaptive codebook of a normally received voiced sound signal frame and FIG. 4 is a graph of a fixed codebook of a normally received voiced sound signal frame. Referring to FIG. 4, it may be appreciated that some pitch period components may also remain in the fixed codebook.

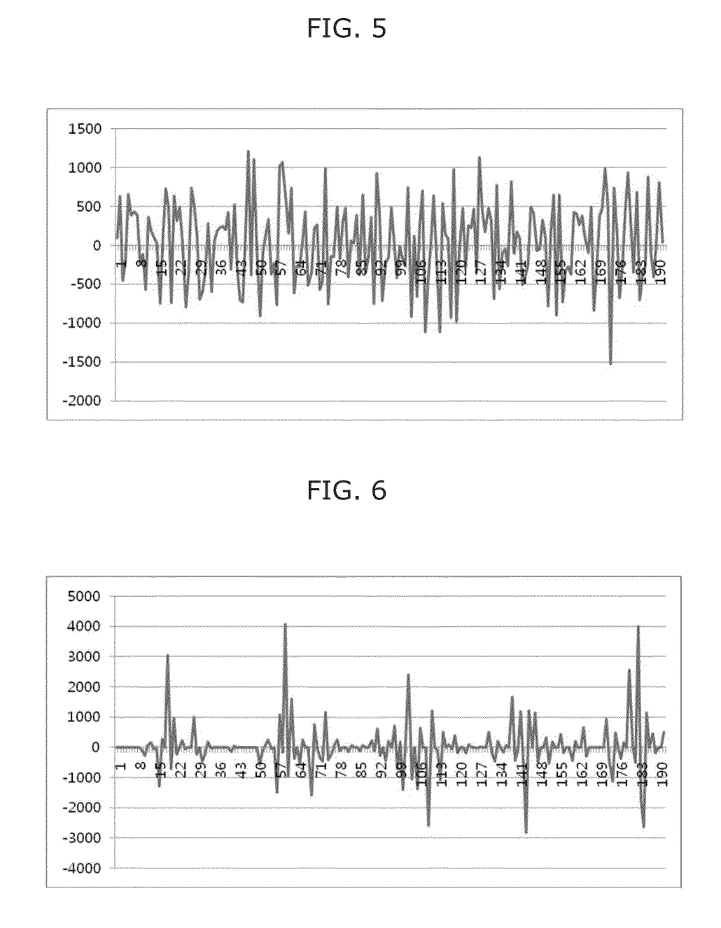

FIG. 5 illustrates a graph of a fixed codebook recovered by the existing algorithm when a frame loss occurs. Referring to FIG. 5, it may be appreciated that the pitch period component does not remain in the fixed codebook recovered by the existing algorithm.

The embodiment of the present invention shapes the fixed codebook recovered using the random function so as to improve the performance of the frame loss concealment algorithm. In particular, the embodiment of the present invention is more effective for the frame loss of the voiced sound period.

FIG. 6 is a graph of a fixed codebook calculated by a method for decoding an audio signal in accordance with the present invention. Comparing the fixed codebook of the normally received frame data as illustrated in FIG. 4, the fixed codebook recovered by the existing algorithm of FIG. 5, and FIG. 6 illustrating the graph of the fixed codebook recovered according the embodiment of the present invention, it may be appreciated that the fixed codebook recovered by the embodiment of the present invention has a shape more approximating to the original fixed codebook than the fixed codebook recovered by the existing algorithm.

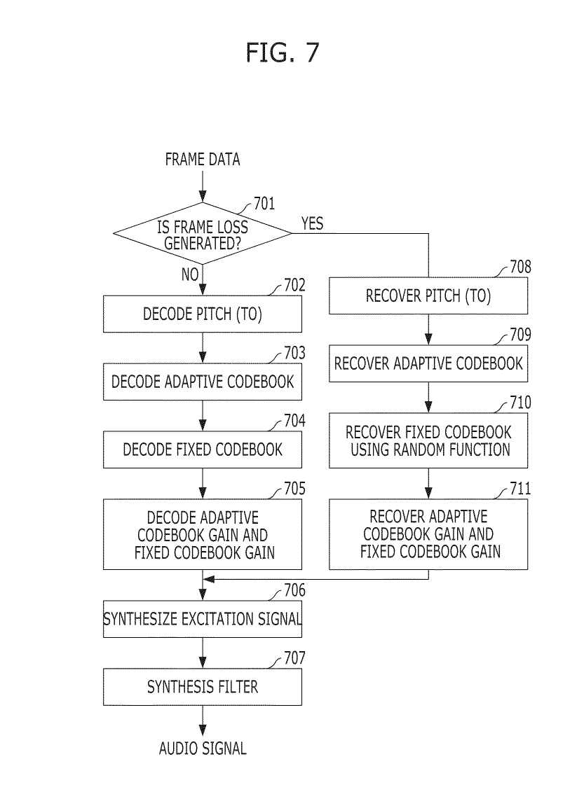

FIG. 7 is a flow chart of a method for decoding an audio signal by a CELP decoder.

First, it is determined whether the frame data is normal by receiving the frame data generated by the encoder (701). When the input frame data is normal, the pitch index is decoded (702) and then, as described with reference to FIG. 2, the adaptive codebook is decoded using the pitch index (703), and the fixed codebook is recovered (704). Further, the gains of each codebook are decoded (705) and then, the excitation signals are synthesized using the values (706). Further, the excitation signals are filtered by the synthesis filter (707) to reproduce the audio signal.

At step 701, when the input frame data is an abnormal frame, the pitch index of the lost frame is first recovered from the pitch index of the previous normal frame (708) and the adaptive codebook value is recovered using the recovered pitch index (709). Further, the fixed codebook value is recovered using the random function (710). Further, the gains of the adaptive codebook and the fixed codebook are recovered using the codebook gain value of the previous normal frame (711). Thereafter, similar to the normal frame decoding, the excitation signals are synthesized using the value and gain of the recovered codebook and the synthesized excitation signal is filtered by the synthesis filter to output the audio signal. The abnormal frame is recovered using the synthesis filter coefficients and the filter coefficients of the previous normal frame.

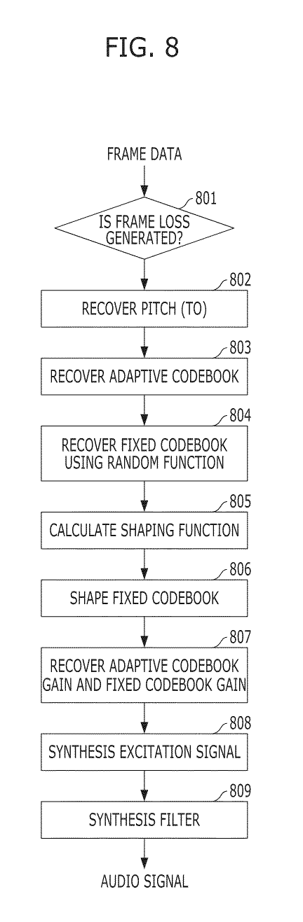

FIG. 8 is a flow chart of a decoding algorithm in accordance with the embodiment of the present invention.

At step 801, when the input frame data is an abnormal or lost data, the pitch is recovered (802) and the adaptive codebook is recovered using the recovered pitch (804). Further, the random function is generated and the fixed codebook is recovered using the generated random function (804). In this case, the fixed codebook recovery (804) may be configured in the subframe unit. The fixed code book recovered as described above may have a shape as shown in FIG. 5.

Next, a shaping function is calculated using the adaptive codebook (805). In this case, the shaping function calculation (805) may be configured in the subframe unit. In another embodiment of the present invention, the shaping function may be calculated by normalizing the adaptive codebook of the corresponding subframe by finding a maximum value in the adaptive codebook of the corresponding frame and using the maximum value. In addition, in another embodiment of the present invention, the calculated shaping function value compares with the predetermined reference value and if it is determined that the shaping function value is smaller than a reference value according to the comparison result, the corresponding function value may be set to be 0. Setting the function value to be 0 is to adjust the number of pulses of the fixed codebook.

Then, the recovered fixed codebook is shaped by using the calculated shaping function (806). In another embodiment of the present invention, the shaping of the fixed codebook using the shaping function (806) may be performed only in the stable voiced sound period.

Thereafter, the gains of the adaptive codebook and the fixed codebook are recovered (807) and the excitation signals are synthesized (808). Further, the audio signal is output through the synthesis filter (809).

As can be appreciated from FIGS. 7 and 8, in the embodiment of the present invention, when the frame loss occurs, the periodicity is emphasized by applying the pitch shaping function to the fixed codebook recovered by the random function and the possible noise may be reduced by using the random function as the fixed codebook.

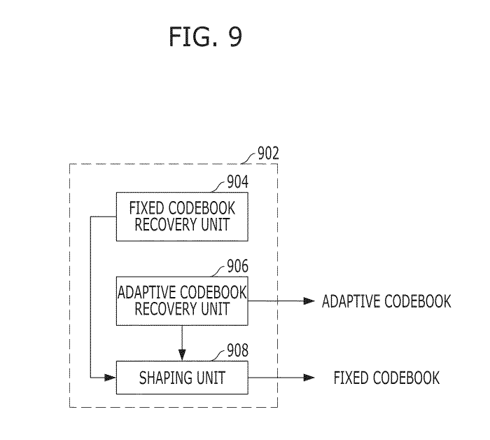

FIG. 9 is a diagram illustrating a configuration of an apparatus for decoding an audio signal in accordance with an embodiment of the present invention.

An apparatus 902 for decoding an audio signal according to the embodiment of the present invention includes a fixed codebook recovery unit 904, an adaptive codebook recovery unit 906, and a shaping unit 908. In addition, although not shown in FIG. 9, the apparatus 902 for decoding an audio signal may further include an input unit receiving the frame data of the audio signal and determining whether the input frame data is a normal data.

The fixed codebook recovery unit 904 recovers the fixed codebook using the random function. In this case, the fixed codebook recovery may be performed in the subframe unit. The fixed code book recovered as described above may have a shape as shown in FIG. 5. Further, the adaptive codebook recovery unit 906 recovers the adaptive codebook for synthesizing the audio signal.

The shaping unit 908 calculates the shaping function by using the adaptive codebook recovered through the adaptive codebook recovery unit 906. In this case, the shaping function calculation may be configured in the subframe unit. In another embodiment of the present invention, the shaping unit 908 may calculate the shaping function by acquiring the maximum value in the adaptive codebook of the corresponding subframe and normalizing the adaptive codebook of the corresponding subframe using the maximum value. In addition, in another embodiment of the present invention, the shaping unit 908 compares the calculated shaping function value with the predetermined reference value and if it is determined that the shaping function value is smaller than a reference value according to the comparison result, the corresponding function value may be set to be 0. Setting the function value to be 0 is to adjust the number of pulses of the fixed codebook.

Next, the shaping unit 908 shapes the recovered fixed codebook using the calculated shaping function. In another embodiment of the present invention, the shaping unit 908 may perform the shaping only in the stable voiced sound period.

The adaptive codebook recovered through the adaptive codebook recovery unit 906 and the fixed codebook output through the shaping unit 908 may be used to synthesize the audio signal in the decoding module as shown in FIG. 2 later. Although not shown in FIG. 9, the apparatus 902 for decoding an audio signal may further include the adaptive codebook recovered through the adaptive codebook recovery unit 906 and an audio signal synthesis unit synthesizing the audio signal using the fixed codebook output through the shaping unit 908.

As described above, the embodiment of the present invention applies the shaping using the shaping function to the fixed codebook recovered by the random function. Therefore, the quality of the synthesized audio signal from the lost frame data may be improved by imparting the pitch component to the fixed codebook. In other words, the embodiments of the present invention can reduce the quality deterioration of the synthesized signal by emphasizing the pitch period and reducing the fixed codebook influence between the pitch periods by recovering the fixed codebook using the shaping function calculated based on the adaptive codebook when the frame data loss occurs.

As described above, the embodiments of the present invention can reduce the quality deterioration of the synthesized signal by emphasizing the pitch period and reducing the fixed codebook influence between the pitch periods by recovering the fixed codebook using the shaping function calculated based on the adaptive codebook when the frame data loss occurs.

While the present invention has been described with respect to the specific embodiments, it will be apparent to those skilled in the art that various changes and modifications may be made without departing from the spirit and scope of the invention. Accordingly, the scope of the invention is not limited to exemplary embodiments as described above and is defined by the following claims and equivalents to the scope the claims.

What is claimed is:

1. A method for decoding an audio signal, comprising:
receiving frame data of the audio signal;
recovering a fixed codebook of the frame data using a random function;
calculating a shaping function using an adaptive codebook of the frame data;
shaping the recovered fixed codebook using the shaping function; and
synthesizing the audio signal from the frame data by using the shaped fixed codebook and the adaptive codebook.

2. The method of claim 1, wherein the recovering of the fixed codebook includes recovering the fixed codebook in a subframe unit of the frame data.

3. The method of claim 1, wherein the calculating of the shaping function includes:
acquiring a maximum value of the adaptive codebook of the subframe of the frame data;
normalizing the adaptive codebook of the subframe using the maximum value; and
calculating the shaping function using the normalized adaptive codebook.

4. The method of claim 1, wherein the calculating of the shaping function includes:
comparing a function value acquired through the shaping function calculation with a predetermined reference value; and
setting the function value to be 0 when the function value is smaller than the reference value according to the comparison result.

5. The method of claim 1, wherein the shaping of the recovered fixed codebook includes shaping the recovered fixed codebook only in a voiced sound period of the audio signal.

6. An apparatus for decoding an audio signal, comprising:
an input unit receiving frame data of the audio signal;
a fixed codebook recovery unit recovering a fixed codebook of the frame data using a random function;
a shaping unit calculating a shaping function using an adaptive codebook of the frame data and shaping the recovered fixed codebook using the shaping function; and
an audio signal synthesis unit synthesizing the audio signal from the frame data by using the shaped fixed codebook and the adaptive codebook.

7. The apparatus of claim 6, wherein the fixed codebook recovery unit recovers the fixed codebook in a subframe unit of the frame data.

8. The apparatus of claim 6, wherein the shaping unit acquires a maximum value of the adaptive codebook of the subframe of the frame data; normalizes the adaptive codebook of the subframe using the maximum value; and calculates the shaping function using the normalized adaptive codebook.

9. The apparatus of claim 6, wherein the shaping unit compares a function value acquired through the shaping function calculation with a predetermined reference value and sets the function value to be 0 when the function value is smaller than the reference value according to the comparison result.

10. The apparatus of claim 6, wherein the shaping unit shapes the recovered fixed codebook only in a voiced sound period of the audio signal.
